(19) United States
(12) Patent Application Publication
(10) Pub. No.: US 2023/0090959 A1
(43) Pub. Date: Mar. 23, 2023

(54) CERIUM-ZIRCONIUM OXIDE-BASED OXYGEN ION CONDUCTOR (CZOIC) MATERIALS WITH HIGH OXYGEN MOBILITY

(71) Applicant: Pacific Industrial Development Corporation, Ann Arbor, MI (US)

(72) Inventors: Anatoly Bortun, Ypsilanti, MI (US); Mila Bortun, Ypsilanti, MI (US); Geng Zhang, Utsunomiya (JP); David Shepard, Canton, MI (US)

(21) Appl. No.: 17/793,979

(22) PCT Filed: Jan. 14, 2021
(86) PCT No.: PCT/US2021/013358

§ 371 Date: Jul. 20, 2022

Related U.S. Application Data
(60) Provisional application No. 62/966,590, filed on Jan. 28, 2020.

(51) Int. Cl. C01G 25/00; B01J 23/10; B01J 23/40; B01D 53/94; H01M 8/1253; H01M 8/126

(52) U.S. Cl. CPC C01G 25/006; B01J 23/10; B01J 23/40; B01D 53/945; H01M 8/1253; H01M 8/126; C01P 2002/52; C01P 2002/77; C01P 2002/88; B01D 2255/407; B01D 2255/908; B01D 2255/102; B01D 2255/2061; B01D 2255/2063; B01D 2255/2068; B01D 2255/2066; H01M 2008/1293

(57) ABSTRACT

A cerium-zirconium oxide-based ionic conductor (CZOIC) material including zirconium oxide in an amount ranging from 5 wt. % up to 95 wt. %, cerium oxide in an amount ranging from 95 wt. % to 5 wt. %, and at least one oxide or a rare earth metal in an amount ranging from 30 wt. % or less, based on the overall mass of the CZOIC material. The CZOIC material exhibits a structure comprising one or more expanded unit cells and a plurality of crystallites having ordered nano-domains. The structure of the CZOIC material exhibits a crystal lattice defined by a d-value measured at multiple (hkl) locations using a SAED technique that exhibit distortions, such that the d-values for the same (hkl) location varies from about 2% to about 5% from the d-value measured for a reference cerium-zirconium material at the same (hkl) location.

### CROSS REFERENCE TO RELATED APPLICATIONS

This application is a national stage filing of International Application No. PCT/US2021/013358 filed on Jan. 14, 2021, designating the United States and published in English, which claims the benefit of the filing date under 35 U.S.C. § 119(e) of U.S. Provisional Application No. 62/966,590 filed on Jan. 28, 2020, the entire contents of which are incorporated herein by reference in their entirety.

### FIELD

This disclosure generally relates to cerium-zirconium oxide-based ion conductor (CZOIC) materials used as oxygen sensors, in solid oxide fuel cells, as catalysts, or in other applications that require fast oxygen mobility and conductivity.

### BACKGROUND

The statements in this section merely provide background information related to the present disclosure and may not constitute prior art.

In a three-way-conversion (TWC) catalyst, a cerium-zirconium oxide-based ion conductor (CZOIC) material is widely used as an oxygen storage material. In order to be successful in this application, the CZOIC material needs to exhibit a high oxygen storage capacity, a high resistance to sintering over a broad temperature range, e.g., up to 1150° C., develop mesoporosity in order to exhibit effective mass transport properties, and provide compatibility with precious metals. Facile oxygen mobility is another important requirement for a CZOIC material. Oxygen mobility is critical for both oxygen release and re-adsorption during rapid environmental changes that occur in an exhaust gas in order to prevent CO/HC breakthrough, especially during periods of acceleration.

Oxygen mobility in CZOIC materials depend on the interaction of multiple factors, such as oxide composition, the type and amount of rare earth dopants that are present, the crystal phase (e.g., tetragonal, cubic, pyrochlore, etc.), and the crystallite size. Extensive research regarding oxygen mobility in CZOIC materials conducted over the past 25 years has resulted in the development of materials that allow efficient operation of TWC catalysts in a temperature range of 300 to 600° C.

However, new stringent requirements regarding the emission levels for CO, NON, HC and soot makes necessary a search for new CZOIC materials that exhibit a facile nature for both the reduction of CeO₂ and the mobility of oxygen within the material's lattice structure at significantly lower temperatures, ideally at ambient temperature. The development of such new CZOIC materials with fast oxygen mobility is important not only for TWC catalyst applications, but also for use as electrolytes in solid oxide fuel cells (SOFCs) in which high conductivity at low temperatures is also required.

### SUMMARY

The objective of the present disclosure is achieved by the combination of features described by cerium-zirconium oxide-based ionic conductor (CZOIC) material formed herein, as well as the incorporation of this CZOIC material in a three-way (TWC) catalyst, a solid oxide fuel cell (SOFC), and a catalyst having fast oxygen ion mobility and conductivity.

The CZOIC material generally comprises zirconium oxide in an amount ranging from 5 wt. % up to 95 wt. %, cerium oxide ranging from 95 wt. % to 5 wt. %, and at least one oxide of a rare earth metal other than cerium ranging from 30 wt. % or less, based on the overall mass of the CZOIC material. The CZOIC material exhibits a structure comprising one or more expanded unit cells and a plurality of crystallites having ordered nano-domains.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a graphical representation of TPR-H₂ profiles for two CZOIC materials (CZ-1, CZ-2) of the present disclosure having different average particle sizes (d₅₀) compared to a ceria-zirconia reference material (CZ-Reference) after aging at 1000° C. for six hours;

FIG. 2 is a graphical representation of TPR-H₂ profiles for CZOIC material (CZ-1) run consecutively to determine the stability of the measured Tₘₐₓ;

FIG. 3 is a graphical representation of a derivative thermogravimetry (DTG) curve for the oxidation of carbon black with and without the presence of the CZOIC material of the present disclosure or a ceria-zirconia reference material;

FIG. 4 is a representation of the crystallographic structure of the ceria-zirconia reference material as measured by selected area electron diffraction (SAED);

FIG. 5 is a representation of the crystallographic structure of the CZOIC material of the present disclosure as measured by selected area electron diffraction (SAED); and

FIG. 6 is a representation of the crystallographic structure of another CZOIC material of the present disclosure as measured by selected area electron diffraction (SAED).

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. For example, the cerium-zirconium oxide-based ion conductor (CZOIC) material made and used according to the teachings contained herein is described throughout the present disclosure in conjunction with a three-way catalyst (TWC) used to reduce vehicle emission gases in order to more fully illustrate the composition and the use thereof. The incorporation and use of such CZOIC material in other catalysts for removing HC, CO, NOx, and soot from gasoline or diesel engines, diesel oxidation catalysts, and other oxidation catalysts, or in other applications, such as oxygen sensors or electrolytes used in solid oxide fuel cells (SOFCs) is contemplated to be within the scope of the present disclosure. It should be understood that throughout the description, corresponding reference numerals indicate like or corresponding parts and features.

The present disclosure generally provides a cerium-zirconium oxide-based ion conductor (CZOIC) material that exhibits a structure that comprises one or more expanded unit cells and a plurality of crystallites having ordered nano-domains. The CZOIC material may comprise, consist of, or consist essentially of oxides of zirconium oxide, cerium oxide, and at least one rare earth metal other than cerium. The CZOIC material may comprise cerium oxide and zirconium oxide, such that the material exhibits a mass ratio of cerium to zirconium (Ce:Zr) that is between about 0.2 and about 1.0. Alternatively, the Ce:Zr ratio is in the range of 0.3 to 0.9; alternatively between 0.4 and 0.8.

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one unit cell”, “one or more unit cells”, and “unit cell(s)” may be used interchangeably and are intended to have the same meaning.

For the purpose of this disclosure the terms “about” and “substantially” are used herein with respect to measurable values and ranges due to expected variations known to those skilled in the art (e.g., limitations and variability in measurements).

Furthermore, any range in parameters that is stated herein as being “between [a 1^{st} number] and [a 2^{nd} number]” or “between [a 1^{st} number] to [a 2^{nd} number]” is intended to be inclusive of the recited numbers. In other words, the ranges are meant to be interpreted similarly as to a range that is specified as being “from [a 1^{st} number] to [a 2^{nd} number]”.

The CZOIC material has a zirconium oxide content that is between about 5% by weight and 95 wt. % relative to the overall weight of the CZOIC material. When desirable, the CZOIC material may have a zirconium oxide content that ranges from 10% to 90% by weight; alternatively, between about 20 wt. % and about 80 wt. % relative to the overall weight of the CZOIC material. The cerium oxide content in the CZOIC material may also range from 5% to 95% by weight; alternatively, between about 10 wt. % to about 90 wt. %; alternatively, from about 20 wt. % to about 80 wt. % relative to the overall weight of the CZOIC material.

For the purpose of this disclosure, the term “weight” refers to a mass value, such as having the units of grams, kilograms, and the like. Further, the recitations of numerical ranges by endpoints include the endpoints and all numbers within that numerical range. For example, a concentration ranging from 40% by weight to 60% by weight (also written as 40 wt. % to 60 wt. %) includes concentrations of 40% by weight, 60% by weight, and all concentrations there between (e.g., 40.1%, 41%, 45%, 50%, 52.5%, 55%, 59%, etc.).

According to another aspect of the present disclosure, the at least one rare earth metal present in the CZOIC other than cerium (Ce) may include dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), yttrium (Y), or mixtures thereof. Alternatively, the rare earth metal present in the CZOIC material other than cerium is selected from the group of lanthanum, neodymium, praseodymium, yttrium, or combination of thereof. The content of these rare earth metals in the CZOIC may range from greater than 0 wt. % up to 35% by weight; alternatively, less than 30 wt. %; alternatively, from about 5 wt. % to 25 wt. %, relative to the overall weight of the CZOIC material. The amount of rare earth metals present in the OSM is sufficient for stabilization of the crystalline lattice of the CZOIC material.

When desirable, the CZOIC material may further comprise one or more transition metals selected, without limitation, from the group of copper, iron, nickel, cobalt, manganese or combination of thereof. The amount of these optional transition metals present in the CZOIC material may range from 0% up to 8% by weight; alternatively, from about 1 wt. % to about 7 wt. %; alternatively, from about 2 wt. % to about 5 wt. %.

The oxygen mobility exhibited by the CZOIC material is due to a combination of the facile nature of Ce⁴⁺⇄Ce³⁺ oxidation/reduction reactions that occur in a typical exhaust gas mixture and the presence of aliovalent ions (La³⁺, Nd³⁺, Y³⁺, etc.) in the crystal lattice structure of the CZOIC material. The presence of these aliovalent ions are responsible for formation of oxygen vacancies in the lattice structure, which enable oxygen migration from the bulk of crystallites to the surface along with the reverse process.

Cerium oxide has the ability to form non-stoichiometric CeO₂₋ₓ surface defect sites, which lead to oxygen vacancies and the formation of active surface oxygen species. Zirconium oxide exhibits a similar effect. When both cerium oxide and zirconium oxide are combined to form the CZOIC material this effect becomes enhanced. In addition to surface oxygen mobility, the zirconium oxide also causes an increase in the mobility of lattice oxygen species due to an increase in the reducibility of Ce⁴⁺ to Ce³⁺. The introduction of zirconium oxide in the cubic cerium oxide lattice increases the generation of defects in the cerium-zirconium oxide-based ion conductor (CZOIC) material, which promotes the mobility of lattice oxygen, thereby allowing the redox reaction that takes place at the surface to occur in the interior of the CZOIC material as well. Zirconium oxide also has the capability to stabilize the crystaline structure during high temperature use.

The following specific examples are given to illustrate the cerium-zirconium oxide-based ion conductor (CZOIC), formed according to the teachings of the present disclosure, as well as the properties thereof and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

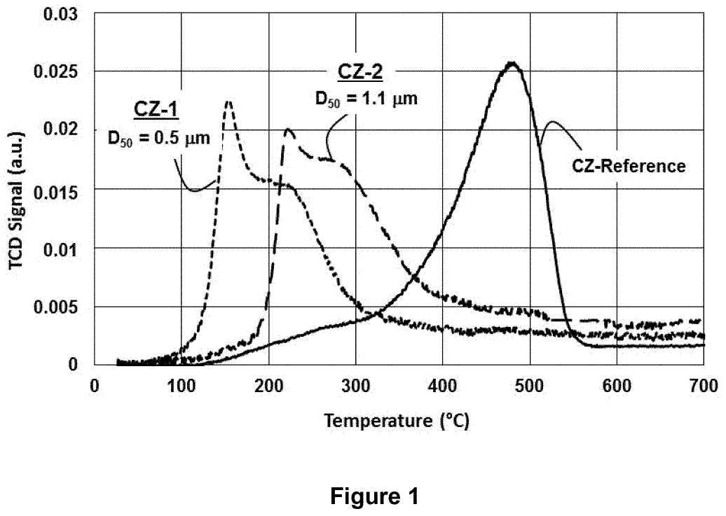

Referring now to FIG. 1, a graphical representation of TPR-H₂ profiles obtained after aging for six hours at 1000° C. is provided for two CZOIC materials (CZ-1; CZ-2) of the present disclosure having different average particle size (d₅₀) and for a ceria-zirconia reference material (CZ-reference) after aging at 1000° C. for six hours. A Micromeritics Autochem 2920 II instrument is used to test temperature programed reduction (TPR) in the temperature range from 25° C. to 900° C. with a temperature ramp 10° C./min and a constant 90% Ar/10% H₂ gas flow rate of 5 cm³/min. TPR-H₂ provides a measurement capable of indicating the amount of active oxygen species and the steps involved in the reduction process of the metal oxides. The difference between the CZ-1 and CZ-2 is the average particle size (D₅₀) exhibited by the CZOIC material. More specifically, the D₅₀ for the CZOIC material of CZ-1 and CZ-2 is 1.1 micrometers (μm) and 0.5 μm, respectively. The CZ-Reference represents a conventional ceria-zirconia material, such as that described in the examples set forth in European Patent No. 1 527 018 B1, the entire content of which is hereby incorporated by reference.

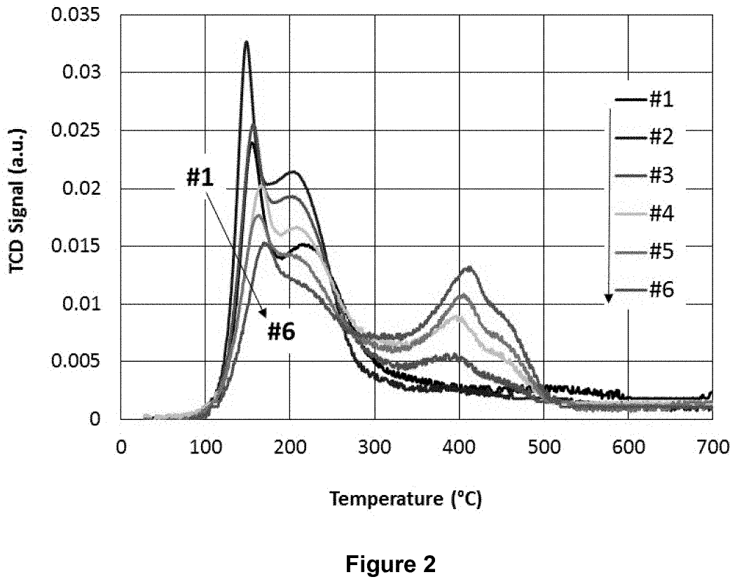

A reduction process that occurs at higher temperatures is usually associated with the mobility of oxygen atoms with the structure of the metal oxide. The CZOIC material of the present disclosure exhibits a fast oxygen ion mobility and conductivity that manifests itself by an occurrence of a Tₘₐₓ measured by TPR-H₂ that occurs at a temperature of 250° C. or less (see CZ-1; CZ-2). In comparison, the CZ-Reference exhibits a Tₘₐₓ measured by TPR-H₂ that occurs at a temperature of about 475° C. The Tₘₐₓ measured by TPR-H₂ for the CZOIC material of the present disclosure remains at a temperature of 250° C. or less after 6 hours aging at 1,000° C. In addition, the TPR-H₂ profiles for the CZOIC material of the present disclosure (CZ-1; CZ-2) exhibit at least 80% or more of a reducible oxygen being present at a temperature below 400° C. Finally, the measurement of consecutive TPR-H₂ runs for CZ-1 (run #1 to run #6) as shown in FIG. 2 demonstrates that the occurrence of the Tₘₐₓ for the CZOIC materials of the present disclosure remains relatively constant with only a slight shift to a higher temperature.

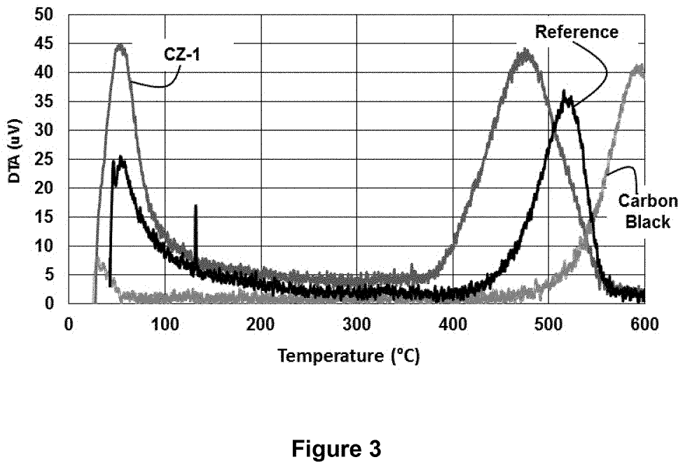

Referring now to FIG. 3, a graphical representation of a derivative thermogravimetry (DTG) curve is provided for the oxidation of carbon black with and without the presence of the CZOIC material of the present disclosure (CZ-1) or a ceria-zirconia reference material (CZ-Reference). Carbon black is used as a simulated soot emitted from a diesel engine. The DTG curves for the CZOIC material of the present disclosure (CZ-1) and the ceria-zirconia reference material (CZ-Reference) are obtained using 5% carbon black mixed with 95% of the mixed oxide material (CZ-1 or CZ-Reference). The DTG curve is measured for a 25 mg sample of the CZOIC material using a Seiko EXTAR 7300 TG/DTA/DSC instrument heated from 25° C. to 700° C. at a ramp rate of 10° C./minute.

A DTG curve represents a measurement of the weight loss or gained at a heating or cooling isotherm over a specified temperature or time (−dm/dt). The occurrence of multiple decomposition processes may overlap, e.g., one decomposition reaction may not be finished when a second (higher temperature decomposition process) commences. However, in most cases a reliable qualitative and quantitative evaluation of a TG curve is impossible without measuring its first derivative (i.e. the DTG curve). The peak height in the DTG curve at any temperature gives the rate of the mass loss.

In FIG. 3, the CZOIC material of the present disclosure (CZ-1) exhibits a fast oxygen ion mobility and conductivity that manifests itself by an ability to oxidize carbon soot or hydrocarbons at less than 500° C. In comparison, the ceria-zirconia reference material (CZ-Reference) oxidizes carbon soot or hydrocarbons at a temperature that is greater than 500° C.; alternatively the ability to oxidize saturated hydrocarbons at less than 300° C. The carbon black in the absence of the CZOIC material is found to oxidize at a temperature closer to 600° C. The DTG curves further demonstrate that at least 10% of an oxygen storage capacity (OSC) is available for carbon monoxide (CO) oxidation at 300° C. or less.

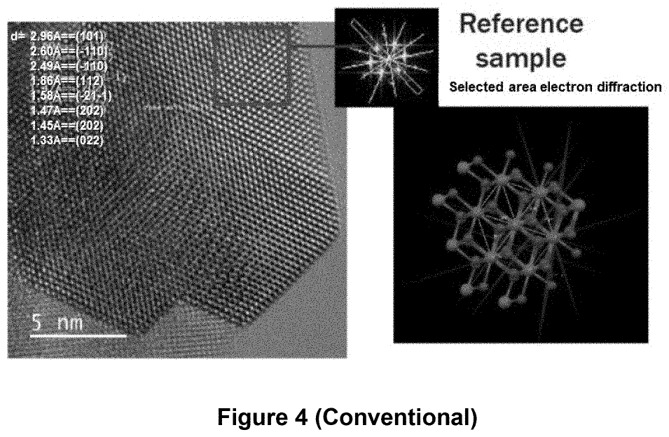

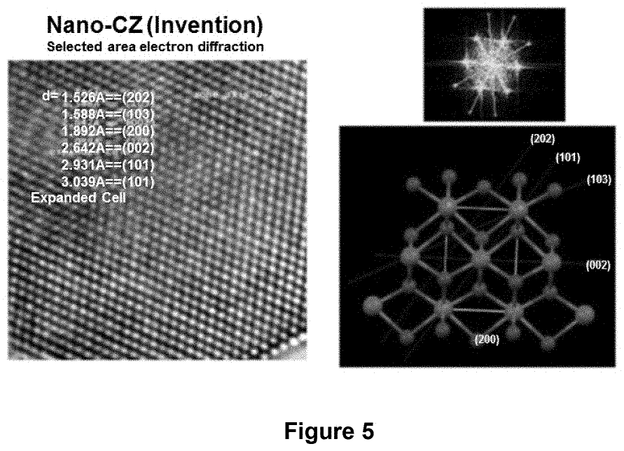

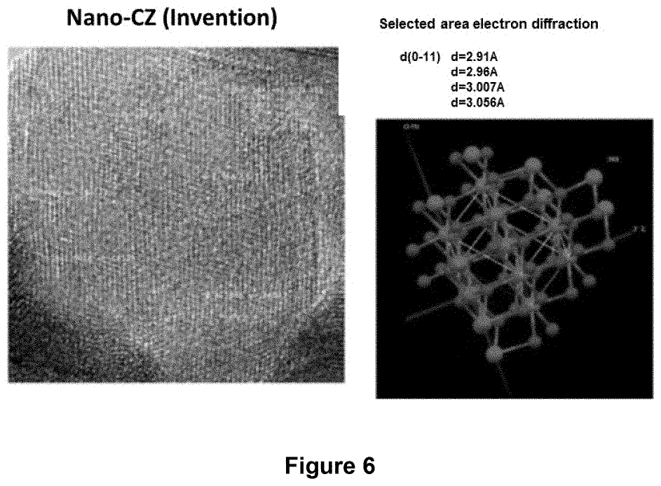

Referring now to FIGS. 4-6 representations of the crystallographic structure of the ceria-zirconia reference material (FIG. 4) and the CZOIC material of the present disclosure (FIGS. 5 & 6) are provided as measured using selected area electron diffraction (SAED). Selected area electron diffraction (SAED) is a crystallographic experimental technique in which a thin crystalline sample (˜100 nm thick) is subjected to a parallel beam of high-energy electrons in a transmission electron microscope (TEM), such that the electrons pass through the sample. Since the wavelengths associated with the electrons are typically on the order of a few thousandths of a nanometer and the spacing between atoms in the crystalline sample is about a hundred times larger, the electrons are diffracted with the atoms act as a diffraction grating. Thus, a fraction of the electrons are scattered to particular angles determined by the crystal structure of the sample, while others pass through the sample without deflection. The resulting TEM image 100 (see FIGS. 4-6) exhibit a series of spots, constituting the diffraction pattern. Each of these spots corresponds to a diffraction condition of the sample's crystal structure. SAED is used to identify crystal structures and examine crystal defects 111 (see FIGS. 4-6). In this respect, SAED is similar to X-ray diffraction, except that areas as small as several hundred nanometers in size can be examined, while X-ray diffraction typically examines areas that are several centimeters in size.

The structure of the CZOIC materials of the present disclosure (FIGS. 5 & 6) exhibit a crystal lattice defined by a d-value measured at multiple (hkl) locations using the SAED technique. More specifically, in FIGS. 5 & 6 different crystallites of CZ-1 are shown along a different zone axis. The measured d-values for the CZOIC materials of the present disclosure exhibit distortions. The d-values measured at multiple (hkl) locations for the CZ-Reference and CZOIC materials of the present disclosure are provided in Table 1. The d-values for the same (hkl) location for the CZOIC materials of the present disclosure varies from about 2% to about 5% from the d-value measured for a reference cerium-zirconium material at the same (hkl) location.

TABLE 1

| (hkl) | CZ-Reference | CZOIC Materials |
|---|---|---|
| (112) | 1.86 A | 1.88 A |
| | | 1.90 A |
| (211) | 1.50 A | 1.59 A |
| (101) | 2.95 A | 2.93 A |
| | 2.96 A | 3.04 A |
| | | 3.06 A |
| (110) | 2.49 A | 2.63 A |
| | 2.60 A | |
| (200) | 1.82 A | 1.89 A |
| (202) | 1.45 A | 1.47 |
| | 1.46 A | 1.53 |
| | 1.47 A | |

According to another aspect of the present disclosure, a catalyst is provided that comprises at least one platinum group metal (PGM) and a cerium-zirconium oxide-based ionic conductor (CZOIC) material as previously described above and further defined herein. The catalyst may be, without limitation, a three-way catalyst, a four-way catalyst, or a diesel oxidation catalyst.

The CZOIC material represents an important portion of the composition of a three-way catalyst (TWC), because the CZOIC material plays a major role in oxygen storage and release under lean and rich fuel conditions, thereby, enabling the oxidation of CO and volatile organics and the reduction of NON. High efficient catalytic performance also relates to high specific surface area and thermal stability, as well as high oxygen storage capacity.

The catalyst composition incorporates one or more platinum group metals (PGM) in an amount that is between about 0.01 wt. % and 10 wt. % relative to the mass of the overall catalyst composition. Alternatively, the PGM is present in an amount that ranges about 0.05 wt. % to about 7.5 wt. %; alternatively, between 1.0 wt. % and about 5 wt. %. The platinum group metal may include but not be limited to platinum (Pt), palladium (Pd), and rhodium (Rh).

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A cerium-zirconium oxide-based ionic conductor (CZOIC) material comprising zirconium oxide in an amount ranging from 5 wt. % up to 95 wt. %, cerium oxide ranging from 95 wt. % to 5 wt. %, and at least one oxide of a rare earth metal other than cerium ranging from 30 wt. % or less, based on the overall mass of the CZOIC material;
wherein the CZOIC material exhibits a structure comprising one or more expanded unit cells and a plurality of crystallites having ordered nano-domains.

2. The CZOIC material according to claim 1, wherein the CZOIC material comprises a mass ratio cerium to zirconium (Ce:Zr) between about 0.2 and about 1.0.

3. The CZOIC material according to claim 1, wherein the rare earth metal is selected from the group of lanthanum (La), neodymium (Nd), praseodymium (Pr), Yttrium (Y), or a combination thereof.

4. The CZOIC material according to claim 1, wherein the structure of the CZOIC material exhibits a crystal lattice defined by a d-value measured at multiple (hkl) locations using a SAED technique that exhibit distortions, such that the d-values for the same (hkl) location varies from about 2% to about 5% from the d-value measured for a reference cerium-zirconium material at the same (hkl) location.

5. The CZOIC material according to claim 1, wherein the CZOIC material exhibits a fast oxygen ion mobility and conductivity that manifests itself by an occurrence of a Tₘₐₓ measured by TPR-H₂ that occurs at a temperature of 250° C. or less.

6. The CZOIC material according to claim 1, wherein the CZOIC material exhibits a fast oxygen ion mobility and conductivity that manifests itself by an occurrence of a Tₘₐₓ measured by TPR-H₂ that occurs at a temperature of 250° C. or less after 6 hours aging at 1,000° C.

7. The CZOIC material according to claim 1, wherein the CZOIC material exhibits a fast oxygen ion mobility and conductivity that manifests itself by an occurrence of at least 80% or more of a reducible oxygen being present as measured by TPR-H₂ at a temperature below 400° C.

8. The CZOIC material according to claim 1, wherein the CZOIC material exhibits a fast oxygen ion mobility and conductivity that manifests itself by an ability to oxidize carbon soot or hydrocarbons at less than 500° C.

9. The CZOIC material according to claim 1, wherein the CZOIC material exhibits a fast oxygen ion mobility and conductivity that manifests itself by at least 10% of an oxygen storage capacity (OSC) is available for carbon monoxide (CO) oxidation at 300° C. or less.

10. The CZOIC material according to claim 8, wherein the ability to oxidize hydrocarbons represents an ability to oxidize saturated hydrocarbons at less than 300° C.

11. (canceled)

12. A three-way conversion (TWC) catalyst that includes an oxygen storage material, the oxygen storage material comprising the CZOIC material according to claim 1.

13. A solid oxide fuel cell (SOFC) having an electrolyte, the electrolyte comprising the CZOIC material according to claim 1.

14. A catalyst having fast oxygen ion mobility and conductivity, the catalyst comprising:
at least one platinum group metal (PGM); and
a cerium-zirconium oxide-based ionic conductor (CZOIC) material comprising zirconium oxide in an amount ranging from 5 wt. % up to 95 wt. %, cerium oxide ranging from 95 wt. % to 5 wt. %, and at least one oxide of a rare earth metal other than cerium ranging from 30 wt. % or less, based on the overall mass of the CZOIC material; wherein the CZOIC material exhibits a structure comprising one or more expanded unit cells and a plurality of crystallites having ordered nano-domains.

15. The catalyst according to claim 14, wherein the CZOIC material comprises a mass ratio cerium to zirconium (Ce:Zr) between about 0.2 and about 1.0.

16. The catalyst according to claim 1, wherein the rare earth metal is selected from the group of lanthanum (La), neodymium (Nd), praseodymium (Pr), Yttrium (Y), or a combination thereof.

17. The catalyst according to claim 14, wherein the structure of the CZOIC material exhibits a crystal lattice defined by a d-value measured at multiple (hkl) locations using a SAED technique that exhibit distortions, such that the d-values for the same (hkl) location varies from about 2% to about 5% from the d-value measured for a reference cerium-zirconium material at the same (hkl) location.

18. The catalyst according to claim 14, wherein the CZOIC material exhibits a fast oxygen ion mobility and conductivity that manifests itself by at least one of the following:
an occurrence of a Tₘₐₓ measured by TPR-H₂ that occurs at a temperature of 250° C. or less;
(ii) an occurrence of at least 80% or more of a reducible oxygen being present as measured by TPR-H₂ at a temperature below 400° C.;
(iii) an ability to oxidize carbon soot or hydrocarbons at less than 500° C.; and
(iv) at least 10% of an oxygen storage capacity (OSC) is available for carbon monoxide (CO) oxidation at 300° C. or less.

19. The catalyst according to claim 14, wherein the CZOIC material exhibits a fast oxygen ion mobility and conductivity that manifests itself by at least one of the following after being exposed to aging at 1000° C. for six hours:
an occurrence of a Tₘₐₓ measured by TPR-H₂ that occurs at a temperature of 250° C. or less;
(ii) an occurrence of at least 80% or more of a reducible oxygen being present as measured by TPR-H₂ at a temperature below 400° C.;
(iii) an ability to oxidize carbon soot or hydrocarbons at less than 500° C.; and
(iv) at least 10% of an oxygen storage capacity (OSC) is available for carbon monoxide (CO) oxidation at 300° C. or less.

20. The catalyst according to claim 18, wherein the ability to oxidize hydrocarbons represents an ability to oxidize saturated hydrocarbons at less than 300° C.

21. The catalyst according to claim 14, wherein the catalyst is a three-way catalyst, a four-way catalyst, or a diesel oxidation catalyst.
